(19) United States
(12) Patent Application Publication
(10) Pub. No.: US 2007/0211193 A1
(43) Pub. Date: Sep. 13, 2007

(54) SURFACE LIGHT SOURCE DEVICE

(75) Inventors: Hae-Il Park, Seoul (KR); Jin-Seob Byun, Seoul (KR); Sang-Yu Lee, Gyoenggi-do (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 10/596,908

(22) PCT Filed: Dec. 24, 2004
(86) PCT No.: PCT/KR04/03429

§ 371 Date: Jun. 28, 2006

(30) Foreign Application Priority Data
Jan. 8, 2004 (KR) 10-2004-0001156

(51) Int. Cl. G02F 1/13357; H01J 1/62

(52) U.S. Cl. 349/70; 313/483; 977/952

(57) ABSTRACT

A surface light source device (100) includes a first substrate (110), an electrode (150), a discharge auxiliary layer (112), a fluorescent layer (114) and a second substrate (120). The discharge auxiliary layer (112) includes carbon nanotubes and an oxide. The surface light source device may further include a florescent layer. The surface light source device (100) may have a discharge fluorescent layer including carbon nanotubes, an oxide and a fluorescent material instead of a discharge auxiliary layer (112) and a fluorescent layer (114). Using carbon nanotubes and an oxide in the surface light source device, a discharge firing voltage and a discharge sustaining voltage may be lowered due to a geometric effect of a carbon nanotube and a high yield of secondary electron. Therefore, efficiency of the surface light source device is improved, so that power consumption of an LCD apparatus is decreased and luminance of the LCD apparatus is increased.

### TECHNICAL FIELD

The present invention relates to a surface light source device and a liquid crystal display apparatus having the surface light source device. More particularly, the present invention relates to a surface light source device and a liquid crystal display apparatus having the surface light source device, capable of lowering a discharge firing voltage and a discharge sustaining voltage.

### BACKGROUND ART

Generally, a liquid crystal display (LCD) apparatus displays an image by using liquid crystal. An LCD apparatus includes a display unit for displaying an image and a backlight assembly. The display unit requires the backlight assembly for emitting a light to provide the display unit with a light.

As for a conventional backlight assembly, a cold cathode fluorescent lamp (CCFL) having a cylindrical shape or a light emitting diode (LED) having a dot shape has been widely used. The CCFL has a high luminance, a long lifetime and a low heat dissipation compared with an incandescent lamp, and the LED has a small size and a low power consumption. However, the CCFL or the LED has a problem of low luminance uniformity.

Accordingly, a backlight assembly having the CCFL or the LED as a light source requires a light guide plate for improving luminance uniformity and optical members such as a diffusion member, a prism sheet, and so on. Thus, an LCD apparatus using the CCFL or the LED has many problems such as large volume, heavy weight and high manufacturing cost, etc.

To overcome aforementioned problems, a surface light source device having a flat plate shape has been developed. The surface light source device includes a light source body having a discharge space and an electrode for generating plasma in the discharge space. A surface light source device has a good optical characteristic and a low power consumption. Therefore, the surface light source device is used for an LCD having a large screen.

As for a surface light soiree device having outer electrodes, however, an interval between the electrodes increases as a size of the surface light source device increases. Thus, a high discharge firing voltage and a high discharge sustaining voltage are required. When the discharge firing voltage and the discharge sustaining voltage are increased, a power consumption of the LCD apparatus is increased, thereby lowering an efficiency of the LCD apparatus. In addition, leakage current and effect of electromagnetic interference may be increased due to a high voltage for driving the LCD apparatus.

In a surface light source device using mercury, vapor pressure of mercury is dependent on temperature, so that initial discharge occurring at below room temperature may be difficult. To overcome this problem, large number of electrons is provided in driving the surface light source device. Accordingly, the discharge firing voltage and the discharge sustaining voltage are required to be lowered by means of easily providing secondary electrons in the surface light source device.

Generally, a metal oxide that has a high secondary electron yield and that is strong for shock by ion in plasma is coated on an electrode. When a surface light source device adopts an inner electrode, a dielectric layer and a material capable of easily emitting secondary electrons are subsequently coated on a surface of an electrode. When a surface light source device adopts an outer electrode, an oxide having a high secondary electron yield may be coated on an inner surface of the surface light source device.

A plasma display panel for a backlight assembly is disclosed in Korean Patent Laid-Open Publication N). 2003-0021909, wherein the plasma display panel includes a plurality of electrodes disposed in a space defined by a front glass substrate and a rear glass substrate, and the electrodes are coated by oxide film. Although the oxide film is coated on the electrodes, most of the oxide films have a low (less than 1) secondary electron yield, so that a voltage drop may not be greatly effective.

### DISCLOSURE OF INVENTION

Technical Problem

The present invention provides a surface light source device capable of decreasing a discharge firing voltage and a discharge sustaining voltage.

The present invention also provides an LCD apparatus including the above-mentioned surface light source device.

Technical Solution

A surface light source device in accordance with an aspect of the present invention includes a first substrate, an electrode formed on an outer surface of the first substrate, a discharge auxiliary layer formed on an inner surface of the first substrate corresponding to a position of the electrode, a fluorescent layer formed on the first substrate having the discharge auxiliary layer, and a second substrate facing the first substrate.

A surface light source device in accordance with another aspect of the present invention includes a first substrate, an electrode formed on an outer surface of the first substrate, a discharge fluorescent layer that is formed on an inner surface of the first substrate, wherein the discharge fluorescent layer includes carbon nanotubes, an oxide and a fluorescent material, and a second substrate facing the first substrate.

A liquid crystal display apparatus in accordance with still another aspect of the present invention has a surface light source device that includes a first substrate, an electrode formed on each side of an outer surface of the first substrate, a discharge auxiliary layer formed on each side of an inner surface of the first substrate, a fluorescent layer formed on the first substrate having the discharge auxiliary layer and a second substrate facing the first substrate, a liquid crystal display panel that displays images by using a light emitted from the surface light source device, and a receiving container that receives the surface light source device and the liquid crystal display panel.

A liquid crystal display apparatus in accordance with still another aspect of the present invention has a surface light source device that that includes a first substrate, an electrode formed on each side of an outer surface of the first substrate, a discharge fluorescent layer formed on an inner surface of the first substrate, the discharge fluorescent layer including carbon nanotubes, an oxide and a fluorescent material, and a second substrate facing the first substrate, a liquid crystal display panel that displays images by using a light emitted from the surface light source device, and a receiving container that receives the surface light source device and the liquid crystal display panel.

According to a surface light source device including carbon nanotubes and an oxide of the present invention, a discharge firing voltage and a discharge sustaining voltage may be lowered by increasing an amount of secondary electrons emission. Therefore, efficiency of a surface light source device is improved, so that power consumption of an LCD apparatus including the surface light source device is decreased and luminance of the LCD apparatus is increased.

### BRIEF DESCRIPTION OF THE DRAWINGS

The above and other advantages of the present invention will become readily apparent by reference to the following detailed description when considered in conjunction with the accompanying drawings wherein:

FIG. 1 is a partially cut out perspective view illustrating a surface light source device in accordance with a first exemplary embodiment of the present invention;

FIG. 2 is a cross-sectional view taken along a line I-I′ in FIG. 1;

FIG. 3 is a partially cut out perspective view illustrating a surface light source device in accordance with a second exemplary embodiment of the present invention;

FIG. 4 is a cross-sectional view taken along a line II-II′ in FIG. 3;

FIG. 5 is a partially cut alt perspective view illustrating a surface light source device in accordance with a third exemplary embodiment of the present invention;

FIG. 6 is a cross-sectional view taken along a line III-III′ in FIG. 5;

FIG. 7 is a partially cut alt perspective view illustrating a surface light source device in accordance with a fourth exemplary embodiment of the present invention;

FIG. 8 is a cross-sectional view taken along a line IV-IV′ in FIG. 7; and

FIG. 9 is an exploded perspective view illustrating an LCD apparatus having a surface light source device in accordance with the present invention.

### BEST MODE FOR CARRYING OUT THE INVENTION

Hereinafter, the best mode of the present invention will be described in detail with reference to the accompanying drawings.

### Embodiment 1 of a Surface Light Source Device

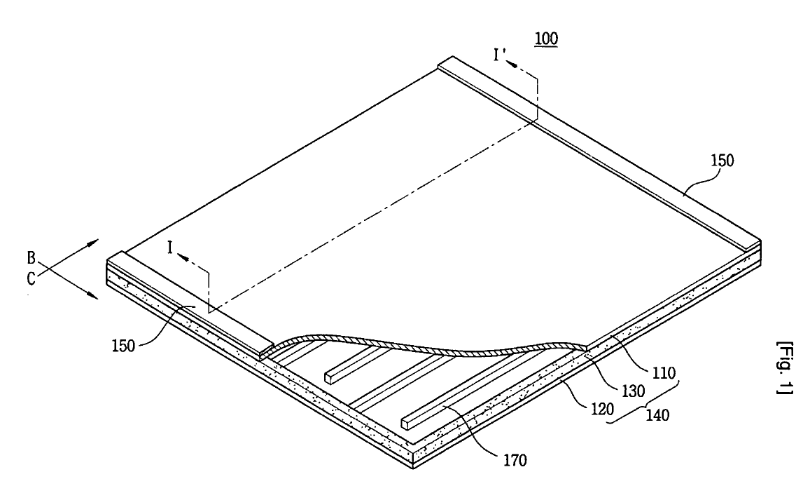

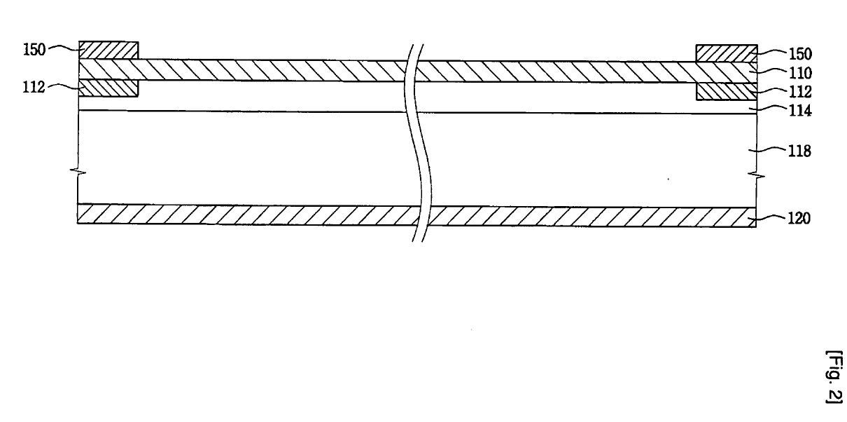

FIG. 1 is a partially cut out perspective view illustrating a surface light source device in accordance with a first exemplary embodiment of the present invention. FIG. 2 is a cross-sectional view taken along a line I-I′ in FIG. 1. FIG. 2 illustrates parts except for sealing members at both ends of the surface light source device in FIG. 1. The line I-I′ passes through a space without a partition member. Thus, the partition member is not shown in FIG. 2.

Referring to FIG. 1, a surface light source device 100 in accordance with one embodiment of the present invention includes a light source body 140 and an electrode 150.

The light source body 140 includes a first substrate 110 and a second substrate 120 facing the first substrate 110. The first and second substrates 110 and 120 are spaced apart from each other. The light source body 140 may further include a sealing member 130 that is disposed between the first and second substrates 110 and 120 to form a discharge space seal a discharge gas.

For example, the first substrate 110 and the second substrate 120 are glass substrates that transmit visible rays and block ultraviolet rays. The sealing member 130 seals edge portion of both the first substrate 110 and the second substrate 120 to form a discharge space. Although the first and second substrates 110 and 120 may have a flat plate shape as shown in FIG. 1, alternatively, one of the first and second substrates 110 and 120 has a plurality of semi-cylindrical shapes that are successively formed. Then, a light source body 140 may not include the sealing member 130, but one of the first and second substrates 110 and 120 having the semi-cylindrical shape successively formed functions as the sealing member 130.

A partition member 170 may be disposed in the discharge space of the light source body 140. At least one of the partition member 170 is disposed substantially parallel to one another at substantially same interval. The partition member 170 makes contact with both the first and second substrates 110 and 120. The partition member 170 may include substantially same material as that of the first substrate 110 or the second substrate 120 when the partition member 170 is simultaneously formed with the first substrate 110 or the second substrate 120. The sealing member 130 may include a material different from that of the partition member 170. Alternatively, the sealing member 130 may include substantially same material as that of the partition member 170 when the sealing member 130 is simultaneously formed with the partition member 170.

The electrode 150 is formed on each side of the cuter surface of the first substrate 110, respectively. A discharge voltage provided from outside is applied to the electrode 150 to generate plasma in a discharge space.

Referring to FIG. 2, a surface light source device 100 further includes a discharge auxiliary layer 112 on the first substrate 110. The discharge auxiliary layer 112 is formed on each side of the inner surface of the first substrate 110 corresponding to a position where the electrode 150 is formed. That is, the discharge auxiliary layer 112 faces the electrode 150 with the first substrate 110 interposed therebetween.

The discharge auxiliary layer 112 includes carbon nanotubes and an oxide. Generally, as for a carbon nanotube, a carbon atom is combined with three carbon atoms to be a hexagonal shape. The carbon nanotube has a geometric enhancement factor corresponding to a given electric field. Thus, the carbon nanotube has a high secondary electron Wield. That is, the carbon nanotube has such a small diameter, and thus has a high aspect ratio. An apex of the carbon nanotube also has such a small diameter, so that the apex of the carbon nanotube easily emits electrons even under the low voltage die to the geometric shape. Accordingly, in the surface light source device 100 including carbon nanotubes, secondary electron yield is increased, so that a discharge firing voltage and a discharge sustaining voltage are lowered and discharging efficiency is improved. Therefore, a power consumption of the surface light source device 100 including carbon nanotubes is reduced and luminance of the LCD apparatus having the surface light scarce device 100 is increased.

The oxide functions as a holder of the carbon nanotubes, and protects the carbon nanotubes from ion shock in plasma. The oxide may spontaneously emit secondary electrons. The oxide has no free electron, so that a scattering effect among electrons is weak. Thus, secondary electrons move onto a surface of the oxide. When sufficient energy is provided, the secondary electrons on the surface of the oxide escape from the surface, so that the secondary electron yield is increased. Therefore, when the surface light source device 100 including the oxide begins discharging, numbers of available electrons are increased, so that the discharge firing voltage and the discharge sustaining voltage may be more lowered than those of a surface light source including only carbon nanotubes.

Metal oxides may be combined with the carbon nanotubes. Examples of the metal oxides are magnesium oxide (MgO), strontium oxide (SrO), barium oxide (BaO), aluminum oxide (Al2O3), etc. Alternatively, nonmetal oxides such as silicon oxide (SiO2) may be used as the oxide.

The carbon nanotubes and the oxide are combined in a paste form. The discharge auxiliary layer 112 may further include a viscosity adjuster and an adhesive to reinforce bond strength of the carbon nanotubes and the oxide with the substrate.

Some of the carbon nanotubes are exposed to the oxide. The exposed carbon nanotubes may preferably be disposed with same intervals on the oxide. It may not be preferable that the interval is less than twice the length of the exposed carbon nanotube die to the electrical screening effect. Accordingly, the intervals may preferably be no less than twice the length of the exposed carbon nanotube. More preferably, the intervals may be about 2 to about 3 times the length of the exposed carbon nanotube.

The discharge auxiliary layer 112 is coated in a band shape along a direction ‘B’ that is same as a direction in which the electrode 150 is disposed. The discharge auxiliary layer 112 may be coated in a substantially same area as that of the electrode 150, and alternatively in a larger or smaller area than that of the electrode 150 according to an amount of the discharge firing voltage required.

The surface light source device 100 in accordance with the present embodiment includes a fluorescent layer 114 on the discharge auxiliary layer 112. The fluorescent layer 114 including fluorescent material converts an ultraviolet light generated by plasma into a visible light. The fluorescent layer 114 is formed on the first substrate 110 in a thin film shape, excluding a region in which the partition member 170 (refer to FIG. 1) is disposed.

Although the fluorescent layer 114 is coated only on the first substrate 110 where the discharge auxiliary layer 112 is coated in the present embodiment, the fluorescent layer 114 may also be coated only on the second substrate 120 where the discharge auxiliary layer 112 is not coated. Alternatively, the fluorescent layer 114 may be coated on both the first and second substrates 110 and 120.

To protect the discharge auxiliary layer 112, a protective layer (not shown) may be formed between the discharge auxiliary layer 112 and the fluorescent layer 114.

A discharge space 118 is formed between the first substrate 110 including the fluorescent layer 114 formed thereon and the second substrate 120. The discharge space 118 is surrounded by the sealing member 130 in FIG. 1. The discharge space 118 contains a discharge gas having mercury (Hg), helium (He), neon (Ne), etc. Due to the electric field generated by the voltage applied to the electrode 150, the secondary electrons are emitted from the discharge auxiliary layer 112. The secondary electrons excite the discharge gas in the discharge space 118, and the excited discharge gas is transferred to a ground state to generate a light.

According to the present embodiment, the surface light source device 100 has a discharge auxiliary layer 112 including carbon nanotubes and an oxide on each side of the inner surface corresponding to a position of the electrode 150. Secondary electron yield of the carbon nanotubes and the oxide is high, so that the discharge firing voltage and the discharge sustaining voltage are lowered. Therefore, the power consumption of the surface light source device 100 is decreased.

### Embodiment 2 of a Surface Light Source Device

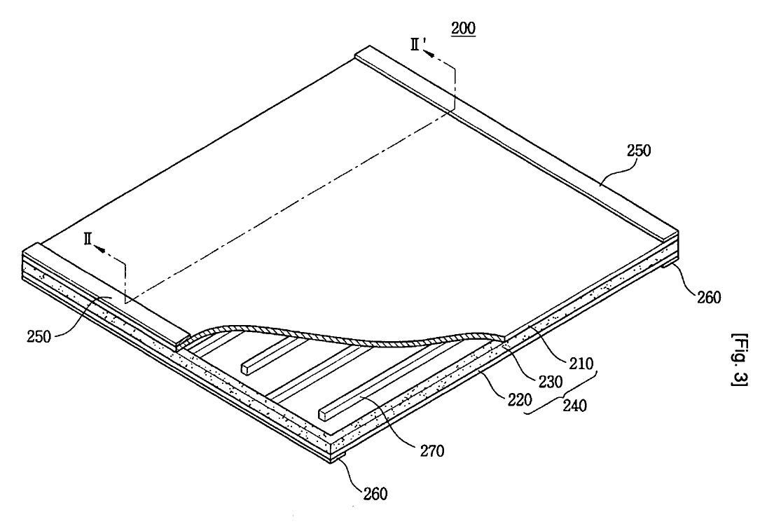

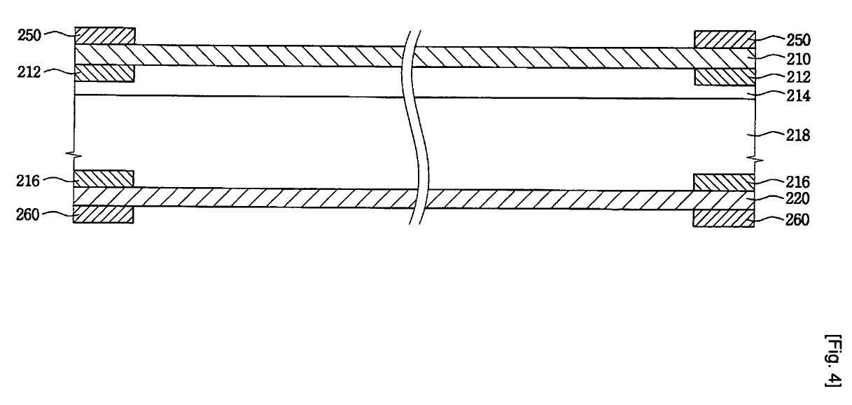

FIG. 3 is a partially cut out perspective view illustrating a surface light source device in accordance with a second exemplary embodiment of the present invention. FIG. 4 is a cross-sectional view taken along the line II-II′ in FIG. 3. FIG. 4 illustrates parts except for sealing members at both ends of the surface light source device in FIG. 3.

Referring to FIG. 3, a surface light source device 200 in accordance with a second exemplary embodiment of the present invention includes a light source body 240, a first electrode 250 and a second electrode 260.

The light source body 240 includes a first substrate 210 and a second substrate 220 disposed at a position corresponding to the first substrate 210. The light source body 240 may further include a sealing member 230 that is disposed between the first substrate 210 and the second substrate 220 to form a discharge space. In the discharge space of the light source body 240, a partition member 270 may be disposed.

The surface light source device 200 in accordance with present embodiment of the present invention is same as in the first embodiment except for a structure of the second substrate 220 having the second electrode 260. Thus, any further explanation for the same elements will be omitted.

Referring to FIG. 4, a surface light source device 200 in accordance with present embodiment of the present invention has a first discharge auxiliary layer 212 and a fluorescent layer 214 formed on the first substrate 210 where the first electrode 250 is disposed.

The first discharge auxiliary layer 212 includes carbon nanotubes and an oxide like a discharge auxiliary layer 112 in the first embodiment. The carbon nanotubes and the oxide are same as in the first embodiment. The carbon nanotubes are exposed on the oxide at regular intervals. The interval may preferably be no less than twice a length of the exposed carbon nanotube. More preferably, the intervals may be about 2 to about 3 times the length of the exposed carbon nanotube.

As for the surface light source device 200 having the first auxiliary layer 212, a discharge firing voltage and a discharge sustaining voltage are lowered, so that discharging efficiency is improved. Accordingly, luminance of an LCD apparatus having the surface light source device 200 is increased, and power consumption is decreased.

The surface light source device 200 includes a second auxiliary layer 216 on the second substrate 220 where the second electrode 260 is disposed. The second electrode 260 corresponding to the first electrode 250 of the first substrate 210 is formed on each side of outer surface of the second substrate 220. The second discharge auxiliary layer 216 is formed on each side of inner surface of the second substrate 220, and includes carbon nanotubes and an oxide. Accordingly, the second discharge auxiliary layer 216 functions as the first discharge auxiliary layer 212.

Although the fluorescent layer 214 is coated only on the first substrate 210 that the first discharge auxiliary layer 212 is coated thereon in the present embodiment, the fluorescent layer 214 may also be coated on the second substrate 220 that the second discharge auxiliary layer 216 is coated thereon.

To protect the first discharge auxiliary layer 212, a protective layer (not shown) may be formed between the first discharge auxiliary layer 212 and the fluorescent layer 214. When the fluorescent layer is coated on the second substrate 220, a protective layer may also be formed to protect the second discharge auxiliary layer 216.

A discharge space 218 is formed between the first substrate 210 and the second substrate 220, so that the surface light source device 200 generates light by discharge gas in the discharge space 218.

The surface light source device 200 in accordance with the present embodiment has the first electrode 250 and the second electrode 260 and has the first discharge auxiliary layer 212 and the second discharge auxiliary layer 216 corresponding to each electrodes, respectively. A high voltage is applied to the surface light source device 200 by the first and second electrodes 250 and 260. Therefore, secondary electrons are easily emitted from the high voltage applied to the electrodes by a mixture of carbon nanotubes and an oxide in the first and second discharge auxiliary layers 212 and 216.

### Embodiment 3 of a Surface Light Source Device

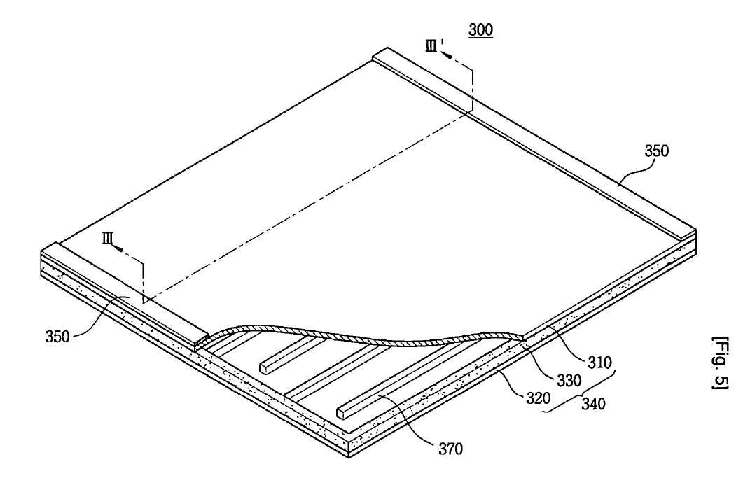

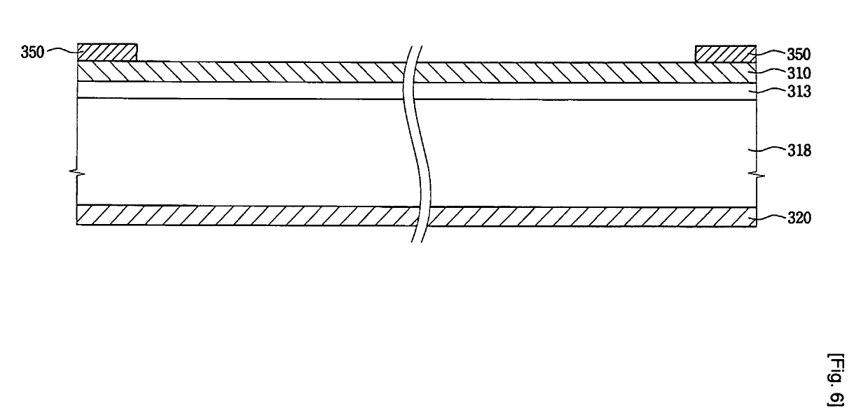

FIG. 5 is a partially act out perspective view illustrating a surface light source device in accordance with a third exemplary embodiment of the present invention. FIG. 6 is a cross-sectional view taken along the line III-III′ in FIG. 5. FIG. 6 illustrates parts except for sealing members at both ends of the surface light source device in FIG. 5.

Referring to FIG. 5, a surface light source device 300 in accordance with a third exemplary embodiment of the present invention includes a light source body 340 and an electrode 350.

The light source body 340 includes a first substrate 310 and a second substrate 320 disposed at a position corresponding to the first substrate 310. The light source body 340 may further include a sealing member 330 that is disposed between the first substrate 310 and the second substrate 320 to form a discharge space 318. In the discharge space 318 of the light source body 340, a partition member 370 may be disposed.

The surface light source device 300 in accordance with the present embodiment is same as in the first embodiment except for a structure of the first substrate 310. Thus, any further explanation for the same elements will be omitted.

Referring to FIG. 6, the surface light source device 300 in accordance with the present embodiment has a discharge fluorescent layer 313 on the first substrate 310 where the electrode 350 is disposed.

The discharge fluorescent layer 313 includes carbon nanotubes, an oxide and a fluorescent material. The carbon nanotubes and the oxide are same as in the first embodiment. The carbon nanotubes are exposed on the oxide and the fluorescent material at regular intervals. The interval may preferably be no less than twice a length of the exposed carbon nanotube. More preferably, the intervals may be about 2 to about 3 times the length of the exposed carbon nanotube. The discharge fluorescent layer 313 performs both a function of the fluorescent layer and a function of the discharge auxiliary layer as described in the first embodiment. Thus, the discharge fluorescent layer 313 converts an ultraviolet light generated by plasma in the discharge space 318 into a visible light, and lowers a discharge firing voltage and a discharge sustaining voltage to improve discharging efficiency. Therefore, luminance of an LCD apparatus having the surface light source device 300 is increased and its power consumption is decreased.

The discharge space 318 is formed between the first substrate 310 and the second substrate 320, so that the surface light source device 300 generates light by discharge gas in the discharge space 318.

### Embodiment 4 of a Surface Light Source Device

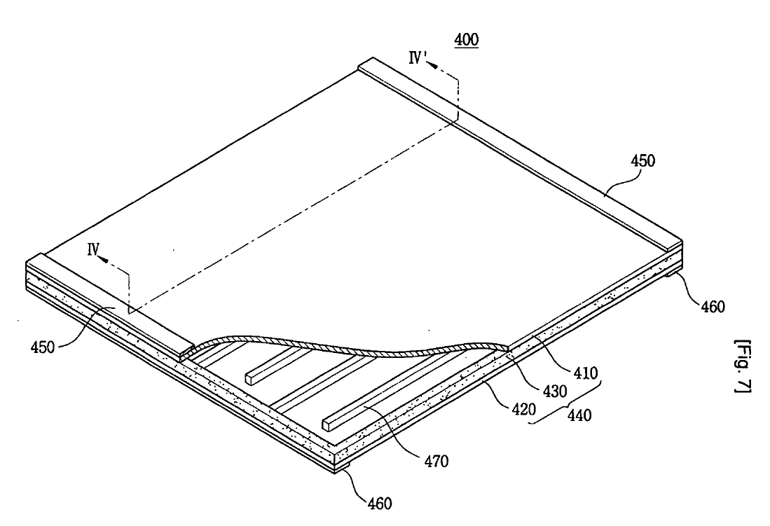

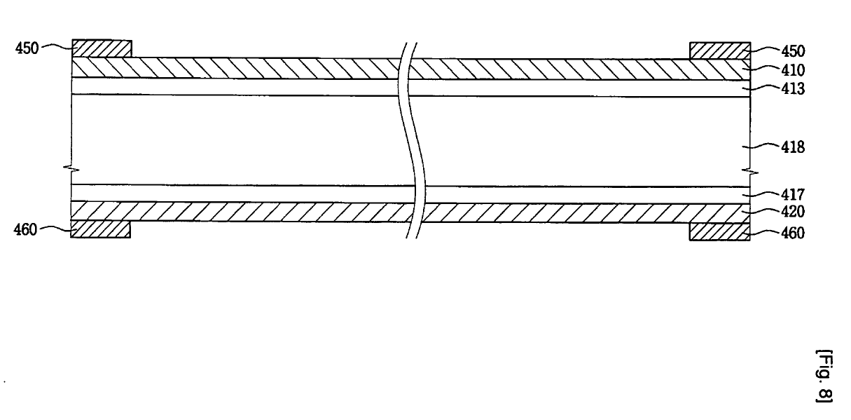

FIG. 7 is a partially cut out perspective view illustrating a surface light source device in accordance with a fourth exemplary embodiment of the present invention. FIG. 8 is a cross-sectional view taken along the line IV-IV′ in FIG. 7. FIG. 8 illustrates parts except for sealing members at both ends of the surface light source device in FIG. 7.

Referring to FIG. 7, a surface light source device 400 in accordance with a fourth exemplary embodiment of the present invention includes a light source body 440, a first electrode 450 and a second electrode 460.

The light source body 440 includes a first substrate 410 and a second substrate 420 disposed at a position corresponding to the first substrate 410. The light source body 440 may further include a sealing member 430 that is disposed between the first substrate 410 and the second substrate 420 to form a discharge space 418. In the discharge space 418 of the light source body 440, a partition member 470 may be disposed.

The surface light source device 400 in accordance with another embodiment of the present invention is same as in the third embodiment except for a structure of the second substrate 420. Thus, any further explanation for the same elements will be omitted.

Referring to FIG. 8, the surface light source device 400 in accordance with the present embodiment has a first discharge fluorescent layer 413 on an inner surface of the first substrate 410 where the first electrode 450 is disposed.

The first discharge fluorescent layer 413 includes carbon nanotubes, an oxide and a fluorescent material like a discharge fluorescent layer 313 in the third embodiment. The carbon nanotubes and the oxide are same as in the first embodiment. The carbon nanotubes are exposed on the oxide at regular intervals. The interval may preferably be no less than twice a length of the exposed carbon nanotube. More preferably, the intervals may be about 2 to about 3 times the length of the exposed carbon nanotube.

As for the surface light source device 400 having the first discharge fluorescent layer 413, a discharge firing voltage and a discharge sustaining voltage are lowered, so that discharging efficiency is improved. Accordingly, luminance of an LCD apparatus having the surface light source device 400 is increased and its power consumption is decreased.

The surface light scarce device 400 includes a second discharge fluorescent layer 417 on the second substrate 420 where the second electrode 460 is disposed. The second electrode 460 is formed on each side of outer surface of the second substrate 420, and corresponds to the first electrode 450 of the first substrate 410. The second discharge fluorescent layer 417 including carbon nanotubes and an oxide is formed on the second substrate 420. Therefore, the second discharge fluorescent layer 417 functions as the first discharge fluorescent layer 413.

The discharge space 418 is formed between the first substrate 410 and the second substrate 420, so that the surface light scarce device 400 generates light by discharge gas in the discharge space 418.

The surface light source device 400 in accordance with the present embodiment has the first electrode 450 and the second electrode 460 and has the first discharge fluorescent layer 413 and the second discharge fluorescent layer 417 corresponding to each electrodes, respectively. A high voltage is applied to the surface light source device 400 by the first and second electrodes 450 and 460. Therefore, secondary electrons are easily emitted from the high voltage applied to the electrodes by a mixture of carbon nanotubes and an oxide in the first and second discharge fluorescent layers 413 and 417.

Hereinafter, an LCD apparatus including a surface light source device in accordance with embodiments of the present invention will be described in detail with reference to the accompanying drawings.

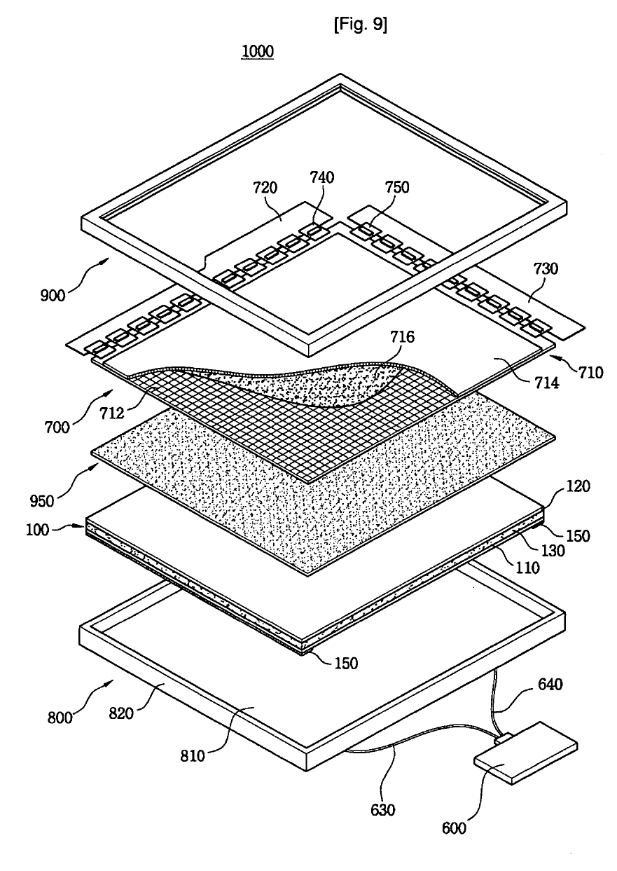

FIG. 9 is an exploded perspective view illustrating an LCD apparatus having a surface light source device in accordance with an exemplary embodiment of the present invention.

Referring to FIG. 9, an LCD apparatus includes a surface light source device 100, a display unit 700 and a receiving container 800.

The surface light source device 100 includes a first substrate 110, a second substrate 120 that is disposed at a position corresponding to the first substrate 110, a sealing member 130 that is disposed between the first substrate 110 and the second substrate 120 to form a discharge space, and an electrode 150 that is formed at each side of the first substrate 110.

The surface light source device 100 applied in the present embodiment is same as in FIG. 1. Thus, any further explanation will be omitted. Although a surface light source in the first embodiment is applied, it is obvious that the surface light source devices of the second to the fourth embodiments may be applied by one ordinary skilled in the art. Accordingly, the surface light source device may have a discharge auxiliary layer on each side of the inner surface of the first substrate 110 corresponding to a position on which the electrode 150 is formed, and a fluorescent layer on the first substrate 110 having the discharge auxiliary layer. The discharge auxiliary layer includes carbon nanotubes and an oxide. In addition, instead of having the discharge auxiliary layer and the fluorescent layer, the surface light source device may have a discharge fluorescent layer including carbon nanotubes, an oxide and a fluorescent material formed on the inner surface of the first substrate 110.

The display unit 700 includes an LCD panel 710, a data printed circuit board (PCB) 720 that provides a driving signal for driving the LCD panel 710, and a gate PCB 730. The data and the gate PCBs 720 and 730 are electrically connected to the LCD panel 710 through a data tape carrier package (TCP) and a gate TCP, respectively.

The LCD panel 710 includes a thin film transistor (TFT) substrate 712, a color filter substrate 714 disposed at a position corresponding to the TFT substrate 712, and liquid crystal interposed between the TFT substrate 712 and the color filter substrate 714.

The TFT substrate 712 is a transparent glass substrate on which TFTs (not shown) and switching elements are formed in a matrix shape. A data and a gate lines are connected to a source electrode and a gate electrode of the TFTs respectively, and a pixel electrode (now shown) is connected to a drain electrode. The pixel electrode includes transparent conductive material.

Color pixels such as red (R), green (G), blue (B) pixels are formed on the color filter substrate 714 through the thin film process. In addition, a common electrode (not shown) may be formed on the color filter substrate 714. The common electrode includes transparent conductive material.

The receiving container 800 includes a bottom surface 810 and a plurality of sidewalls 820 that form a receiving space. The receiving container 800 fixes the surface light source device 100 and the LCD panel 710 so as to prevent drifting of the surface light source device 100 and the LCD panel 710.

The bottom surface 810 has a sufficient bottom area, so that the surface light source device 100 is mounted thereon, and may have substantially identical shape as the surface light source device 100. The sidewall 820 extends substantially perpendicular to the bottom surface 810 from an edge portion of the bottom surface 810. An insulation member may be formed on the bottom surface 810 to insulate the electrode 150 from the bottom surface 810.

An LCD apparatus 1000 in, accordance with the present embodiment further includes an inverter 600 and a top chassis 900.

The inverter 600 is disposed outside the receiving container 800 to provide a discharge voltage for driving the surface light source device 100. The discharge voltage generated from the inverter 600 is applied to the surface light source device 100 thrush a first power supply cable 630 and a second power supply cable 640. The first and second power supply cables 630 and 640 may be directly connected to an electrode 150. Alternatively, the first and second power supply cables 630 and 640 may also be connected to the electrode 150 through a separated connection member (not shown).

The top chassis 900 is combined with the receiving container 800 surrounding edge portions of the LCD panel 710. The top chassis 900 protects the LCD panel 710 from an impact that is externally provided to the LCD apparatus 1000. The top chassis 900 combines the LCD panel 710 with the receiving container 800.

The LCD apparatus 1000 may further include at least one optical sheet member 950. The optical sheet member 950 may include a diffusing plate and various optical sheets. The optical sheet may include a diffusion sheet for diffusing a light or a prism sheet for increasing luminance of the light.

The LCD apparatus 1000 may further include a mold frame disposed between the optical member 950 and the surface light source device 100 to support the optical member 950.

Although the surface light source device 100 in the first embodiment has been described above, the LCD apparatus in accordance with the present invention may include a surface light source device of the second to fourth embodiments.

As for the surface light source device including carbon nanotubes and an oxide, a discharge firing voltage and a discharge sustaining voltage may be lowered by increasing an amount of secondary electrons emission. Therefore, efficiency of the surface light source device is improved, so that power consumption of the LCD apparatus including the surface light source device is decreased, and the luminance of the LCD apparatus is increased.

### INDUSTRIAL APPLICABILITY

As mentioned above, a surface light source device and an LCD apparatus having the surface light source device in accordance with the present invention include carbon nanotubes and an oxide in a discharge auxiliary layer or in a fluorescent layer by combining with a fluorescent material. Therefore, a discharge firing voltage and a discharge sustaining voltage of the surface light source device are lowered, thereby improving discharging efficiency.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A surface light source device, comprising:
a first substrate;
an electrode formed on an outer surface of the first substrate;
a discharge auxiliary layer formed on an inner surface of the first substrate corresponding to a position of the electrode;
a fluorescent layer formed on the first substrate having the discharge auxiliary layer; and
a second substrate facing the first substrate.

2. The surface light source device of claim 1, wherein the discharge auxiliary layer comprises carbon nanotubes and an oxide.

3. The surface light source device of claim 2, wherein the oxide comprises at least one selected from the group consisting of magnesium oxide (MgO), strontium oxide (SrO), barium oxide (BaO), aluminum oxide (Al2O3) and a mixture thereof.

4. The surface light source device of claim 2, wherein the oxide is silicon dioxide (SiO2).

5. The surface light source device of claim 2, wherein the carbon nanotubes and the oxide are combined in a paste form.

6. The surface light source device of claim 2, wherein the discharge auxiliary layer further comprises a viscosity adjuster and an adhesive.

7. The surface light source device of claim 2, wherein the carbon nanotubes are exposed on the oxide.

8. The surface light source device of claim 7, wherein the carbon nanotubes are exposed at regular intervals on the oxide and the interval is no less than twice a length of the exposed carbon nanotubes.

9. The surface light source device of claim 1, further comprising a sealing member disposed between the first and second substrates to form a discharge space seal a discharge gas.

10. The surface light source device of claim 1, further comprising the fluorescent layer on the second substrate.

11. The surface light source device of claim 1, wherein the electrode is formed on each side of the outer surface of the first substrate and the discharge auxiliary layer is formed on each side of the inner surface of the first substrate corresponding to a position of the electrode.

12. The surface light source device of claim 1, further comprising:
an electrode formed on an outer surface of the second substrate; and
a discharge auxiliary layer formed on an inner surface of the second substrate, the discharge auxiliary layer comprising carbon nanotubes and an oxide.

13. The surface light source device of claim 12, wherein the electrode is formed on each side of the aster surface of the second substrate and the discharge auxiliary layer is formed on each side of the inner surface of the second substrate.

14. A surface light source device, comprising:
a first substrate;
an electrode formed on an outer surface of the first substrate;
a discharge fluorescent layer formed on an inner surface of the first substrate, the discharge fluorescent layer comprising carbon nanotubes, an oxide and a fluorescent material; and
a second substrate facing the first substrate.

15. The surface light source device of claim 14, wherein the carbon nanotubes and the oxide are combined in a paste form.

16. The surface light source device of claim 14, further comprising a sealing member disposed between the first substrate and the second substrate to form a discharge space seal a discharge gas.

17. The surface light source device of claim 14, further comprising the fluorescent layer on the second substrate.

18. The surface light source device of claim 14, wherein the electrode is formed on each side of the outer surface of the first substrate.

19. The surface light source device of claim 14, further comprising:
an electrode formed on an outer surface of the second substrate; and
a discharge fluorescent layer formed on an inner surface of the second substrate, the discharge fluorescent layer comprising carbon nanotubes, an oxide and a fluorescent material.

20. The surface light source device of claim 19, wherein the electrode is formed on each side of the alter surface of the second substrate.

21. The surface light source device of claim 14, wherein the carbon nanotubes are exposed at regular intervals on the oxide and the fluorescent material, and the interval is no less than twice a length of the exposed carbon nanotubes.

22. A liquid crystal display apparatus comprising:
a surface light source device that includes a first substrate, an electrode formed on each side of an outer surface of the first substrate, a discharge auxiliary layer formed on each side of an inner surface of the first substrate corresponding to a position of an electrode, a fluorescent layer formed on the first substrate having the discharge auxiliary layer, and a second substrate facing the first substrate;
a liquid crystal display panel that displays an image by using a light emitted from the surface light source device; and
a receiving container that receives the surface light source device and the liquid crystal display panel.

23. The apparatus of claim 22, wherein the discharge auxiliary layer comprises carbon nanotubes and an oxide.

24. The apparatus of claim 23, wherein the carbon nanotubes and the oxide are combined in a paste form.

25. The apparatus of claim 22, wherein the carbon nanotubes are exposed at regular intervals on the oxide, and the interval is no less than twice a length of the exposed carbon nanotubes.

26. A liquid crystal display apparatus comprising:
a surface light source device that includes a first substrate, an electrode formed on each side of an outer surface of the first substrate, a discharge fluorescent layer formed on an inner surface of the first substrate, the discharge fluorescent layer comprising carbon nanotubes, an oxide and a fluorescent material, and a second substrate facing the first substrate;
a liquid crystal display panel that displays images by using a light emitted from the surface light source device; and
a receiving container that receives the surface light source device and the liquid crystal display panel.

27. The apparatus of claim 26, wherein the carbon nanotubes are exposed at regular intervals on the oxide and the fluorescent material, and the interval is no less than twice a length of the exposed carbon nanotubes.
